(19) United States
(12) Patent Application Publication
(10) Pub. No.: US 2018/0002837 A1
(43) Pub. Date: Jan. 4, 2018

(54) Technology for Recovery, Regeneration and Reuse of Soluble Textiles

(71) Applicants: Yanping YU, Shanghai City (CN); Weiguo LIU, Shandong (CN); Erqi YU, Shanghai City (CN); Junhe LIU, Shandong (CN)

(72) Inventors: Yanping YU, Shanghai City (CN); Weiguo LIU, Shandong (CN); Erqi YU, Shanghai City (CN); Junhe LIU, Shandong (CN)

(21) Appl. No.: 15/333,174

(22) Filed: Oct. 24, 2016

(30) Foreign Application Priority Data
Jun. 30, 2016 (CN) 201610494197.8

(51) Int. Cl. D01G 11/00; C08J 11/08; D01G 21/00

(52) U.S. Cl. CPC D01G 11/00; D01G 21/00; C08J 11/08; C08J 2367/02; D10B 2331/04

(57) ABSTRACT

The invention discloses a technology for recovery, regeneration and reuse of soluble textiles. The technology comprises the steps of: the dissolution-controlled soluble polyester fibres are processed into soluble apparel accessories through conventional weaving, dyeing, finishing and tailoring or injection molding; the apparels or the soluble apparel accessories are dissolved under a certain condition, on one hand, the dissolving solution is filtered and solutes are recovered to obtain a high purity of terephthalic acid and ethylene glycol, which are reused to the polymerization of the soluble polyester, and the slices of the soluble polyester are obtained to be re-spun into the soluble fibres for reuse; on the other hand, the incompact and undissolved textiles are treated into an incompact fibre aggregation with good qualities by processes including disinfection, decolourization or redyeing, which are processed into high-quality textile fibres for reuse after drying or softly carding.

### BACKGROUND OF THE INVENTION

The invention relates to the field of fibre processing, textile processing and environmental technology, in particular to a technology for recovery, regeneration and reuse of soluble textiles.

All over the world, countless textiles have become unusable waste product or are used in a lower level, which cause enormous waste of resources and secondary pollution of the environment. There is no technology or product for simply treating and recovering the prior art textile fibres, the main causes of which are the complexities of the compositions, colors and ready-made apparel accessories of the textile raw materials, and the great damage of the opened fibres due to the compactness of the fabric structure, which results in low value in use.

At present, only textiles with high value such as pure cashmere and aramid fibres are opened and carded in the market to acquire fibres with low strength and short length, the recovery of which is of low value.

While another route for recovery is making PET fibres by recovering PET bottles, then cleaning and pelletizing, the fibre textiles made in this way can not be used, which will become wastes and contaminants. Alternatively, the recovered pure pet apparels are subjected to decomposition using high-temperature fusion and chemical alcoholysis to obtain pta, however this method is high cost, and is only applicable to 100% pet fabrics, rather than other blending non-PET fabrics. Therefore, the above methods have great limitations.

### BRIEF SUMMARY OF THE INVENTION

The invention aims at providing a technology for recovery, regeneration and reuse of soluble textiles in view of the defects of the prior art, which comprises the steps of preparing soluble fibres, textile processing, dissolving and recovering textiles, and retreating nonsoluble textiles;

The step of preparing soluble fibres includes preparing the dissolution-controlled soluble fibres such as filament fibre, staple fibre and fibre rod under different media and dissolution conditions;

The step of textile processing can be the design and processing of textiles making of 100% soluble fibres as raw materials, also the processing of textiles made of blending soluble fibres with other fibres, including apparel accessories, for example, sewing threads, buttons, logos, tags, washing tags and the like for textiles, which can be formed from soluble substances;

The step of dissolution and recovery of textiles comprises dissolving the soluble fibres under a certain condition, and the dissolved soluble fibre substances are subjected to recovery in a high-purity way and sewage treatment to achieve the purposes of material recovery and environmental protection; the 100% soluble fibre textiles are subjected to recovery in a high-purity way, and the dissolved regenerant can be used directly as raw materials for producing controlled soluble fibres or used directly as polymer raw materials for controlled soluble fibres; and as for the dissolution of the blending or interweaving products made of the dissolution-controlled fibres, the residual nonsoluble fibres become an incompact textile due to the dissolution of the dissolution-controlled fibres;

The step of retreating the residual textiles comprises disinfecting and chemically treating according to the requirements for use, and decoloring or bleaching and then redyeing according to the requirements for future use, the residual textiles are loosen or even broken up due to the dissolution of soluble fibres, which can be made into high-quality fibres containing additional compositions after being softly carded, and leading to less damage in strength and low loss in length to the fibres, or the bleached or colored fibres can be processed into new yarns directly in spinning factories, and the high-quality fibres recovered which blending or interweaving other components of textiles can also be used as raw materials in spinning factories, thereby achieving the efficient and high-quality recovery and reuse in full circulation of the textiles.

The above objectives can be realized by the following technical solutions according to the present invention.

1. A technology for recovery, regeneration and reuse of soluble textiles comprises the steps of:

a. Preparation of the dissolution-controlled soluble fibres and soluble apparel accessories:

during the polymerization of polyester materials, terephthalic acid, isophthalic acid, ethylene glycol, and 5-sodiumsulfonate-isophthalic acid polyglycol ester are added at different proportions of the total weight of polymers, which are polymerized in various combinations and at different proportions to obtain alkali-dissolved slices with intrinsic viscosity of 0.40-0.80 under different alkali dissolution conditions, which are treated by processes of strip casting, cooling, pelletizing, drying and screening sequentially;

1. The dissolution-controlled fibres are prepared according to the conventional spinning process, which including filament fibres, staple fibres and fibre rods, as well as differential and colored fibres of these fibres, to be used for producing various textiles such as ready-made garments, non-woven fabrics and electrostatic flocking;

2. The sewing threads are prepared from the dissolution-controlled fibres according to the conventional process, which are pure spinning yarn or blended yarn of soluble staple fibres, or yarn and twisted yarn of soluble filament fibres;

3. Hard soluble apparel accessories, including logos in the form of zippers, buttons and films, washing tags, component tags and brand tags and the like are produced from the soluble slices under the dissolution-controlled conditions according to the conventional injection molding, addition of masterbatches and shaping processes;

b. Preparation of textiles containing soluble fibres and finished product thereof:

1. Finished product containing 100% dissolution-controlled fibres:

11. The Finished product containing 100% dissolution-controlled fibres is prepared from 100% dissolution-controlled fibres, staple fibre yarn or filament yarn by use of the conventional weaving process, dyeing if necessary, i.e. without adding dissolving media such as alkali substances, the other processes are the same with the conventional processing technology for polyester;

12. The finished products containing 100% dissolution-controlled fibres in addition with elastic fibres such as spandex is produced by the conventional weaving process, dyeing if necessary, i.e. without adding dissolving media such as alkali substances, the other processes are the same with the conventional processing technology for polyester;

2. The finished product made of blending or interweaving dissolution-controlled fibres with other nonsoluble fibres:

21. The finished product made of blending or interweaving dissolution-controlled fibres with other nonsoluble fibres, such as finished product made of blending or interweaving cotton, wool and hemp with other chemical fibres by use of the conventional weaving process, dyeing if necessary, i.e. without adding dissolving media such as alkali substances, the other processes are the same with the conventional processing technology for polyester;

22. The finished product made of blending or interweaving dissolution-controlled fibres with other nonsoluble fibres in addition with elastic fibres such as spandex, such as finished product made of blending or interweaving cotton, wool and hemp with other chemical fibres in addition with elastic fibres such as spandex by use of the conventional weaving process, dyeing if necessary, i.e. without adding dissolving media such as alkali substances, the other processes are the same with the conventional processing technology for polyester;

c. The dissolution and recovery of the finished product containing soluble fibres and soluble apparel accessories:

1. The dissolution and recovery of fabric and soluble apparel accessories containing 100% dissolution-controlled fibres:

11. The fabric or soluble apparel accessories containing 100% dissolution-controlled fibres are completely dissolved in various tanks under a certain solvent condition directly. The dissolved solution is subjected to processes such as membrane filtration, acid precipitation and gasification, etc. to obtain a high purity of terephthalic acid, ethylene glycol and NaOH, and the chemical oxygen demand (COD) of the discharged wastewater meets the requirements of environmental protection;

12. The fibre fabric or soluble apparel accessories containing 100% dissolution-controlled fibres in addition with elastic fibres such as spandex are completely dissolved in various tanks under a certain solvent condition directly. The dissolved solution is subjected to processes such as membrane filtration, acid precipitation and gasification, etc. to obtain a high purity of terephthalic acid, ethylene glycol and NaOH, and the chemical oxygen demand (COD) of the discharged wastewater meets the requirements of environmental protection; the undissolved elastic fibres such as spandex are intercepted by a filtration grid, the content of which is less and maintains in a continuous spandex form, and is easily to be identified and taken away, or the elastic fibres such as spandex are dissolved by solvents which are special for them, the amount of the solvents is less and can be recovered and reused;

2. The dissolution and recovery of fibre fabric or soluble apparel accessories made of blending or interweaving dissolution-controlled fibres with other nonsoluble fibres:

The dissolution-controlled fibres are dissolved by putting such textiles directly into various tanks under certain solvent, media and solubility conditions; meanwhile nonsoluble fibres are cleaned and disinfected, which are formed into an incompact fibre aggregation due to the dissolution of soluble fibres;

The dissolved solution is subjected to processes such as grid filtration, membrane filtration, acid precipitation and gasification, etc. to obtain a high purity of terephthalic acid, ethylene glycol and NaOH, and the chemical oxygen demand (COD) of the discharged wastewater meets the requirements of environmental protection;

The dissolution-controlled fibres and elastic fibres such as spandex are dissolved by putting the finished product made of blending or interweaving dissolution-controlled fibres with other nonsoluble fibres in addition with elastic fibres such as spandex, such as finished product made of blending or interweaving cotton, wool and hemp with other chemical fibres in addition with elastic fibres such as spandex directly into various tanks under certain solvent, media and solubility conditions, such solvents can be a pure one or dissolution complexes of solvents dissolving dissolution-controlled fibres and elastic fibres such as spandex respectively; the dissolution-controlled fibres can also be dissolved in tanks, then the elastic fibres such as spandex are dissolved by solvents which are special for them and which can be recovered and reused;

The incompact and nonsoluble fibre aggregation can be regenerated and disinfected with a disinfectant; or can be used as mottled fibres after being dried directly and softly carded; or the fibres which are decolored are used as bleached fibres after being bleached, oven dried and softly carded according to the requirements for regeneration and use; or the fibres which are decolored are used as colored fibres after being redyed, oven dried and softly carded. The strength and length of fibres are less damaged after the incompact fibre aggregation is softly carded, which ensures the spinnability and wearing performances of nonsoluble fibres;

d. Obtaining a high purity of chemical raw materials and a high quality of fibrous materials:

chemical raw materials recovered after the above treatments: 1. a high purity of terephthalic acid, ethylene glycol and NaOH, which are suitable for industry use; 2. the regenerated fibres after primary treatment have high retention rate in strength and no loss in length.

Wherein, in the step a, the spinning temperature is 270-300° C., and the injection molding temperature is 150-250° C.

Wherein, the alkali solution used in the step c can be sodium hydroxide solution or a low-alkali or alkali-free high-temperature pure water solution or an organic solvent.

The beneficial effects of the present invention are: according to the technology for recovery, regeneration and reuse of soluble textiles of the present invention, the dissolved solution from dissolving the textiles is subjected to processes such as grid filtration, membrane filtration, acid precipitation and gasification, etc. to obtain a high purity of terephthalic acid, ethylene glycol and NaOH, and the chemical oxygen demand (COD) of the discharged wastewater meets the requirements of environmental protection; for the blending or interweaving textiles of the soluble fibres, the compactness textiles can be made into an incompact and nonsoluble fibre aggregation by the dissolution of soluble fibres in the textiles; the nonsoluble fibre aggregation can be regenerated and disinfected with a disinfectant or can be used as mottled fibres after being dried directly and softly carded, or the fibres which are decolored are used as bleached fibres after being bleached, oven dried and softly carded according to the requirements for regeneration and use; or the fibres which are decolored are used as colored fibres after being redyed, oven dried and softly carded. The strength and length of fibres are less damaged after the incompact fibre aggregation is softly carded, which ensures the spinnability and wearing performances of nonsoluble fibres. The technology of the present invention enables the valueless and environment contaminating textiles to become a valuable commodity, which can not only reduce environmental pollutions, but also achieve the purpose of recycling.

### BRIEF DESCRIPTION OF THE DRAWINGS

The invention is further illustrated in combination with the following drawing, however the embodiments in the drawing shouldn't be considered as limitations to the invention.

FIG. 1 shows the structural schematic diagram of the recovery of alkali solution according to the present invention.

### DETAILED DESCRIPTION OF THE INVENTION

The present invention is described in combination with the specific embodiments below.

Embodiment 1, the technology for the dissolution, recovery and reuse of the fabrics and soluble apparel accessories containing 100% dissolution-controlled soluble fibres, comprises the following processing steps:

a. During the polymerization of the polyester raw materials, 5-sodiumsulfonate-isophthalic acid polyglycol ester by weight of 6% of the total weight of polymer and isophthalic acid by weight of 4% of the total weight of polymer were added, pulped and agitated, meanwhile heated to 230° C., then the mixture was transferred to a reaction kettle and polyethylene glycol by weight of 10% of the total weight of polymer was added to dilute and cool the mixture to 210° C., additional polyethylene glycol by weight of 10% of the total weight of polymer was added to the reaction kettle continuously within 50 minutes with agitating, the temperature was increased to 230° C. under atmospheric pressure and the mixture polymerized under vacuum, the alkaline degradation slices with intrinsic viscosity of 0.65 obtained after polymerization were subjected to processes such as strip casting, cooling, pelletizing, drying and screening;

The above alkaline degradation slices were made into alkali-soluble degradation filament fibres, which are filament fibres easily dissolved and degraded in alkali solutions, wherein the processes for spinning and post-treatment of spinning comprising: obtaining POY filaments by conventional POY spinning process at the spinning temperature of 290° C., the POY filaments can dissolve in an alkali solution, then low elastic yarn DTY was produced on an elasticizer. Wherein, the indexes of the fibres are: fineness of 15.5 tex/48 F, strength of 3.6 cn/dtex, and break elongation of 25%. FDY filaments with 150D/48 F, strength of 4.0 cn/dtex, and break elongation of 20% were produced by conventional spinning process;

b. Various fabrics, ready-made garments and textiles are made from the above DTY filaments by conventional process;

1. The sewing threads of the textiles can be prepared by the above FDY filaments after being twisted;

2. The above ready-made garments and textiles are decorated with the apparel accessories, which are hard soluble apparel accessories made of the soluble slices by conventional injection molding, addition of masterbatches for coloring and shaping processes, including logos in the form of zippers, buttons and films, washing tags, component tags and brand tags and the likes;

c. the soluble fibres were dissolved by adding 10 g/L of 100% NaOH and 2 g/L of penetrant into a closed general overflow tank in the dyeing and finishing factory, at the dissolution temperature of 110° C. for 60 minutes in a bath ratio of 1:10;

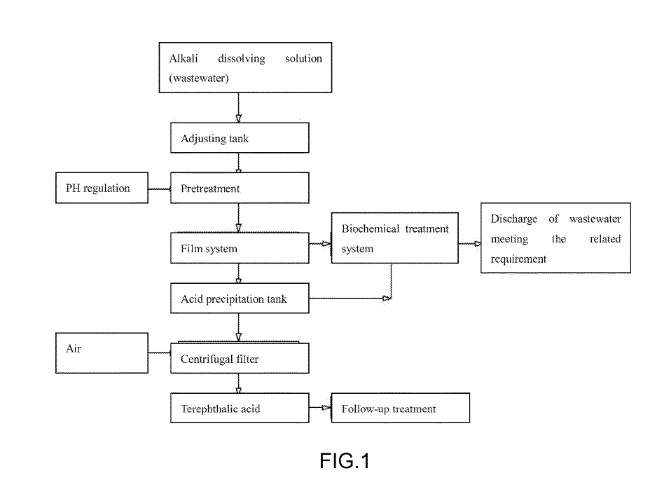

d. As shown in FIG. 1, the dissolution-controlled fibre textiles were dissolved in the alkali solution inside the tank, the dissolved solution is introduced into an adjusting tank through a grid, the alkali solution in the adjusting tank was pretreated and passed through film system sequentially, and entered an acid precipitation tank via the alkali solution in the film system, and the acid solution was pumped into the acid precipitation tank through an acid addition pump, wastewater of pH 3-4 was obtained after the acid solution and the alkali dissolved solution were agitated in the acid precipitation tank, during which the terephthalic acid was separated out. After the acid solution and the alkali dissolved solution were completely reacted in the acid precipitation tank, the waste water in the acid precipitation tank was introduced into a centrifugal filter to separate out the terephthalic acid, which was then washed or not washed according to various requirements and bagged and stored for shipping. The filtrate after acid precipitation was passed through the filtering membrane system to separate out ethylene glycol. Wherein, the grid was mainly used to intercept larger particulate matters and other large-diameter contaminants in water, such as impurities and flotages, and the adjusting tank was used to buffer water amount, uniform water quality and deposit larger solid particulate matters to facilitate the following treatment processes. The COD of the sewage filtrated by the centrifugal filter can be lowered to a great extent, and the filtrate can be subjected to biochemical treatment, the COD of which was further lowered after the ethylene glycol was filtered by the film system, thus meeting the requirements for discharging wastewater from printing and dyeing, and finally entering the biochemical treatment system for sewage in the factory.

Embodiment 2, the technology for the dissolution, recovery and reuse of fibre fabrics and soluble apparel accessories of blended yarn fabric consisting of dissolution-controlled soluble fibres and cellulose fibres, comprises the following steps:

a. The dissolution-controlled soluble staple fibres made in Embodiment 1 were blended with the cellulose fibres such as cotton, hemp and artificial fibre, with blending ratios of 65/35, 50/50, etc.; the yarn count was based on the specification of conventional cellulose fibres or blended yarn; the weaving was performed according to conventional process; and the active dye and dispersive dye dyeing processes of polyester and cellulose fibres two-bath process were adopted in the dyeing process, thereby making the fabrics including tatted fabrics and knitted fabrics;

1. The sewing threads of the textiles can be prepared by the above blended yarn of the staple fibres after being twisted;

2. The above ready-made garments and textiles are decorated with the apparel accessories, which are hard soluble apparel accessories made of the soluble slices by conventional injection molding, addition of masterbatches for coloring and shaping processes, including logos in the form of zippers, buttons and films, washing tags, component tags and brand tags and the likes;

b. Cleaning, disinfection and dissolution were performed as follows: the soluble fibres were dissolved by adding 100% of 8 g/L NaOH and 2 g/L of penetrant into a closed tank, at the dissolution temperature of 110° C. for 60 minutes in a bath ratio of 1:10, then which were disinfected and cleaned by adding disinfectant and an abluent;

As shown in FIG. 1, the dissolved solution discharged is introduced into an adjusting tank through a grid, the alkali solution in the adjusting tank was pretreated and passed through film system sequentially, and entered an acid precipitation tank via the alkali solution in the film system, and the acid solution was pumped into the acid precipitation tank through an acid addition pump, wastewater of pH 3-4 was obtained after the acid solution and the alkali dissolved solution were agitated in the acid precipitation tank, during which the terephthalic acid was separated out. After the acid solution and the alkali dissolved solution were completely reacted in the acid precipitation tank, the waste water in the acid precipitation tank was introduced into a centrifugal filter to separate out the terephthalic acid, which was then washed or not washed according to various requirements and bagged and stored for shipping. The filtrate after acid precipitation was passed through the filtering membrane system to separate out ethylene glycol. Wherein, the grid was mainly used to intercept larger particulate matters and other large-diameter contaminants in water, such as impurities and flotages, and the adjusting tank was used to buffer water amount, uniform water quality and deposit larger solid particulate matters to facilitate the following treatment processes. The COD of the sewage filtrated by the centrifugal filter can be lowered to a great extent, and the filtrate can be subjected to biochemical treatment, the COD of which was further lowered after the ethylene glycol was filtered by the film system, thus meeting the requirements for discharging wastewater from printing and dyeing, and finally entering the biochemical treatment system for sewage in the factory;

The nonsoluble fibres were sequentially decoloured and bleached by the reductive decolouring process, the disinfected, decoloured and bleached cotton fibre incompact aggregation can be coloured and dried according to the dyeing process for conventionally bleached cotton as required, and the bleached incompact aggregation can also be dried directly. Finally, the dried cotton fibres were softly carded and opened, which were slightly decreased in the strength and length, maintaining the spinnability and wearing performances of the original fibres, thereby obtaining a high-quality regenerated cotton fibres, which can be recycled for producing high-quality yarn.

Embodiment 3, the technology for the dissolution, recovery and reuse of fibre fabrics and soluble apparel accessories of blended yarn fabric consisting of dissolution-controlled soluble fibres and cellulose fibres in addition with spandex fibre textiles, comprises the following steps:

a. Staple fibres with 38 mm of length, 1.5D of fineness, 3.6 cn/tex of strength and 25% of break elongation were made of polymerized raw materials from Embodiment 1 by conventional spinning process, and the dissolution-controlled soluble staple fibres were blended with cellulose fibres (such as cotton, hemp and artificial fibres, with the blending ratios of 65/35, 50/50 and the like, and the yarn obtained was interwoven with spandex or twisted with elastic yarn, and tatted or knitted fabrics were made by conventional weaving process; and the active dye and dispersive dye dyeing processes of polyester and cellulose fibres two-bath process were adopted in the dyeing process, thereby making the fabrics including tatted fabrics and knitted fabrics, which were sewed to textile finished product;

1. The sewing threads of the textiles can be prepared by the above blended yarn of the staple fibres after being twisted;

2. The above ready-made garments and textiles are decorated with the apparel accessories, which are hard soluble apparel accessories made of the soluble slices by conventional injection molding, addition of masterbatches for coloring and shaping processes, including logos in the form of zippers, buttons and films, washing tags, component tags and brand tags and the likes;

b. Cleaning, disinfection and dissolution were performed as follows: the soluble fibres were dissolved by adding 100% of 8 g/L NaOH and 2 g/L of penetrant into a closed tank, at the dissolution temperature of 110° C. for 60 minutes in a bath ratio of 1:10, then which were disinfected and cleaned by adding disinfectant and an abluent;

As shown in FIG. 1, the dissolved solution discharged is introduced into an adjusting tank through a grid, the alkali solution in the adjusting tank was pretreated and passed through film system sequentially, and entered an acid precipitation tank via the alkali solution in the film system, and the acid solution was pumped into the acid precipitation tank through an acid addition pump, wastewater of pH 3-4 was obtained after the acid solution and the alkali dissolved solution were agitated in the acid precipitation tank, during which the terephthalic acid was separated out. After the acid solution and the alkali dissolved solution were completely reacted in the acid precipitation tank, the waste water in the acid precipitation tank was introduced into a centrifugal filter to separate out the terephthalic acid, which was then washed or not washed according to various requirements and bagged and stored for shipping. The filtrate after acid precipitation was passed through the filtering membrane system to separate out ethylene glycol. Wherein, the grid was mainly used to intercept larger particulate matters and other large-diameter contaminants in water, such as impurities and flotages, and the adjusting tank was used to buffer water amount, uniform water quality and deposit larger solid particulate matters to facilitate the following treatment processes. The COD of the sewage filtrated by the centrifugal filter can be lowered to a great extent, and the filtrate can be subjected to biochemical treatment, the COD of which was further lowered after the ethylene glycol was filtered by the film system, thus meeting the requirements for discharging wastewater from printing and dyeing, and finally entering the biochemical treatment system for sewage in the factory;

The nonsoluble fibres in the tank were dissolved by adding dimethylacetamide (DMAC) liquid, with a bath ratio of 1:1, at temperature of 95° C. for 30 minutes, then the DMAC liquid was discharged and stored in a liquid collector for reuse in the next circulation; The nonsoluble fibres were sequentially decoloured and bleached, wherein the reductive decolouring process was used for decolouring, the disinfected, decoloured and bleached cotton fibre incompact aggregation can be coloured and dried according to the dyeing process for conventionally bleached cotton as required, and the bleached incompact aggregation can also be dried directly. Finally, the dried cotton fibres were softly carded and opened, which were slightly decreased in the strength and length, maintaining the spinnability and wearing performances of the original fibres, thereby obtaining a high-quality regenerated cotton fibres, which can be recycled for producing high-quality yarn.

Embodiment 4, the technology for the dissolution, recovery and reuse of the finished products of blended textiles made of the dissolution-controlled soluble fibres and wool fibres, comprises the following steps:

a. During the polymerization of the polyester raw materials, 5-sodiumsulfonate-isophthalic acid polyglycol ester by weight of 10% of the total weight of polymer and isophthalic acid by weight of 4% of the total weight of polymer were added, pulped and agitated, meanwhile heated to 230° C., then the mixture was transferred to a reaction kettle and polyethylene glycol by weight of 15% of the total weight of polymer was added to dilute and cool the mixture to 210° C., additional polyethylene glycol by weight of 15% of the total weight of polymer was added to the reaction kettle continuously within 50 minutes with agitating, the temperature was increased to 230° C. under atmospheric pressure and the mixture polymerized under vacuum, the alkaline degradation slices with intrinsic viscosity of 0.55 obtained after polymerization were subjected to processes such as strip casting, cooling, pelletizing, drying and screening;

The above alkaline degradation slices were made into alkali-soluble degradation staple fibres at a spinning temperature of 275° C., which are wool-type fibres with 110 mm of length, 2.5 cn/dtex of strength and 30% of break elongation, and were made into 20 g/5 m fibre rods after being softly carded. During the wool spinning, the yarn was made by twisting fibre rods with wool rods at a blending ratio of 50 soluble fibres/50 wool fibres, Nm was 60, and the fabrics and textiles were made by conventional weaving process and dyeing under alkali-free conditions;

1. The sewing threads of the wool blended textiles can be prepared by the above wool blended yarn after being twisted.

2. The above ready-made garments and textiles are decorated with the apparel accessories, which are hard soluble apparel accessories made of the soluble slices by conventional injection molding, addition of masterbatches for coloring and shaping processes, including logos in the form of zippers, buttons and films, washing tags, component tags and brand tags and the likes;

b. the soluble fibres were dissolved by adding 100% of 1.5 g/L NaOH and 2 g/L of penetrant into a closed tank, at the dissolution temperature of 90° C. for 60 minutes in a bath ratio of 1:10;

As shown in FIG. 1, the dissolved solution discharged is introduced into an adjusting tank through a grid, the alkali solution in the adjusting tank was pretreated and passed through film system sequentially, and entered an acid precipitation tank via the alkali solution in the film system, and the acid solution was pumped into the acid precipitation tank through an acid addition pump, wastewater of pH 3-4 was obtained after the acid solution and the alkali dissolved solution were agitated in the acid precipitation tank, during which the terephthalic acid was separated out. After the acid solution and the alkali dissolved solution were completely reacted in the acid precipitation tank, the waste water in the acid precipitation tank was introduced into a centrifugal filter to separate out the terephthalic acid, which was then washed or not washed according to various requirements and bagged and stored for shipping. The filtrate after acid precipitation was passed through the filtering membrane system to separate out ethylene glycol. Wherein, the grid was mainly used to intercept larger particulate matters and other large-diameter contaminants in water, such as impurities and flotages, and the adjusting tank was used to buffer water amount, uniform water quality and deposit larger solid particulate matters to facilitate the following treatment processes. The COD of the sewage filtrated by the centrifugal filter can be lowered to a great extent, and the filtrate can be subjected to biochemical treatment, the COD of which was further lowered after the ethylene glycol was filtered by the film system, thus meeting the requirements for discharging wastewater from printing and dyeing, and finally entering the biochemical treatment system for sewage in the factory;

The undissolved incompact wool fibre aggregation were decoloured and bleached to obtain the regenerated wool fibres maintaining good strength and length.

The above contents are only the preferred embodiments of the invention. As for an ordinary person skilled in the art, various modifications can be made to the specific embodiments and scope of applications on the basis of the spirit of the invention, and the contents of the invention shouldn't be considered as limitations on the invention.

The above contents are only the preferred embodiments of the invention. As for an ordinary person skilled in the art, various modifications can be made to the specific embodiments and scope of applications on the basis of the spirit of the invention, and the contents of the invention shouldn't be considered as limitations on the invention.

What is claimed is:

1. A technology for recovery, regeneration and reuse of soluble textiles, characterized by, comprising the steps of:
a. Preparation of the dissolution-controlled soluble fibres and soluble apparel accessories:
during the polymerization of polyester raw materials, terephthalic acid, isophthalic acid, ethylene glycol, and 5-sodiumsulfonate-isophthalic acid polyglycol ester are added at different proportions of the total weight of polymers, which are polymerized in various combinations and at different proportions to obtain alkali-dissolved slices with intrinsic viscosity of 0.40-0.80 under different alkali dissolution conditions, the alkali-dissolved slices are treated by processes of strip casting, cooling, pelletizing, drying and screening sequentially;
1. The dissolution-controlled fibres are prepared according to the conventional spinning process, which including filament fibres, staple fibres and fibre rods, as well as differential and colored fibres of these fibres, to be used for producing various textiles such as ready-made garments, non-woven fabrics and electrostatic flocking;
2. The sewing threads are prepared from the dissolution-controlled fibres according to the conventional process, which are pure spinning yarn or blended yarn of soluble staple fibres, or yarn and twisted yarn of soluble filament fibres;
3. Hard soluble apparel accessories, including logos in the form of zippers, buttons and films, washing tags, component tags and brand tags and the like are produced from the soluble slices under the dissolution-controlled conditions according to the conventional injection molding, addition of masterbatches and shaping processes;
b. Preparation of textiles containing soluble fibres and finished product thereof:
1. Finished product containing 100% dissolution-controlled fibres:
11. The Finished product containing 100% dissolution-controlled fibres is prepared from 100% dissolution-controlled fibres, staple fibre yarn or filament yarn by use of the conventional weaving process, dyeing if necessary, i.e. without adding dissolving media such as alkali substances, the other processes are the same with the conventional processing technology for polyester;
12. The finished products containing 100% dissolution-controlled fibres in addition with elastic fibres such as spandex is produced by the conventional weaving process, dyeing if necessary, i.e. without adding dissolving media such as alkali substances, the other processes are the same with the conventional processing technology for polyester;
2. The finished product made of blending or interweaving dissolution-controlled fibres with other nonsoluble fibres:
21. The finished product made of blending or interweaving dissolution-controlled fibres with other nonsoluble fibres, such as finished product made of blending or interweaving cotton, wool and hemp with other chemical fibres by use of the conventional weaving process, dyeing if necessary, i.e. without adding dissolving media such as alkali substances, the other processes are the same with the conventional processing technology for polyester;
22. The finished product made of blending or interweaving dissolution-controlled fibres with other nonsoluble fibres in addition with elastic fibres such as spandex, such as finished product made of blending or interweaving cotton, wool and hemp with other chemical fibres in addition with elastic fibres such as spandex by use of the conventional weaving process, dyeing if necessary, i.e. without adding dissolving media such as alkali substances, the other processes are the same with the conventional processing technology for polyester;
c. The dissolution and recovery of the finished product containing soluble fibres and soluble apparel accessories:
1. The dissolution and recovery of fabric and soluble apparel accessories containing 100% dissolution-controlled fibres:
11. The fabric or soluble apparel accessories containing 100% dissolution-controlled fibres are completely dissolved in various tanks under a certain solvent condition directly. The dissolved solution is subjected to processes such as membrane filtration, acid precipitation and gasification, etc. to obtain a high purity of terephthalic acid, ethylene glycol and NaOH, and the chemical oxygen demand (COD) of the discharged wastewater meets the requirements of environmental protection;
12. The fibre fabric or soluble apparel accessories containing 100% dissolution-controlled fibres in addition with elastic fibres such as spandex are completely dissolved in various tanks under a certain solvent condition directly. The dissolved solution is subjected to processes such as membrane filtration, acid precipitation and gasification, etc. to obtain a high purity of terephthalic acid, ethylene glycol and NaOH, and the chemical oxygen demand (COD) of the discharged wastewater meets the requirements of environmental protection; the undissolved elastic fibres such as spandex are intercepted by a filtration grid, the content of which is less and maintains in a continuous spandex form, and is easily to be identified and taken away, or the elastic fibres such as spandex are dissolved by solvents which are special for them, the amount of the solvents is less and can be recovered and reused;
2. The dissolution and recovery of fibre fabric or soluble apparel accessories made of blending or interweaving dissolution-controlled fibres with other nonsoluble fibres:
The dissolution-controlled fibres are dissolved by putting such textiles directly into various tanks under certain solvent, media and solubility conditions; meanwhile nonsoluble fibres are cleaned and disinfected, which are formed into an incompact fibre aggregation due to the dissolution of soluble fibres;
The dissolved solution is subjected to processes such as grid filtration, membrane filtration, acid precipitation and gasification, etc. to obtain a high purity of terephthalic acid, ethylene glycol and NaOH, and the chemical oxygen demand (COD) of the discharged wastewater meets the requirements of environmental protection;
The dissolution-controlled fibres and elastic fibres such as spandex are dissolved by putting the finished product made of blending or interweaving dissolution-controlled fibres with other nonsoluble fibres in addition with elastic fibres such as spandex, such as finished product made of blending or interweaving cotton, wool and hemp with other chemical fibres in addition with elastic fibres such as spandex directly into various tanks under certain solvent, media and solubility conditions, such solvents can be a pure one or dissolution complexes of solvents dissolving dissolution-controlled fibres and elastic fibres such as spandex respectively; the dissolution-controlled fibres can also be dissolved in tanks, then the elastic fibres such as spandex are dissolved by solvents which are special for them and which can be recovered and reused;
The incompact and nonsoluble fibre aggregation can be regenerated and disinfected with a disinfectant; or can be used as mottled fibres after being dried directly and softly carded; or the fibres which are decolored are used as bleached fibres after being bleached, oven dried and softly carded according to the requirements for regeneration and use; or the fibres which are decolored are used as colored fibres after being redyed, oven dried and softly carded. The strength and length of fibres are less damaged after the incompact fibre aggregation is softly carded, which ensures the spinnability and wearing performances of nonsoluble fibres;
d. Obtaining a high purity of chemical raw materials and a high quality of fibrous materials:
chemical raw materials recovered after the above treatments: 1. a high purity of terephthalic acid, ethylene glycol and NaOH, which are suitable for industry use; 2. the regenerated fibres after primary treatment have high retention rate in strength and no loss in length.

2. The technology for recovery, regeneration and reuse of the soluble textiles according to claim 1, characterized by: in the step a, the spinning temperature is 270-300° C., and the injection molding temperature is 150-250° C.

3. The technology for recovery, regeneration and reuse of the soluble textiles according to claim 2, characterized by: the alkali solution used in the step c can be sodium hydroxide solution or a low-alkali or alkali-free high-temperature pure water solution or an organic solvent.
